(19) United States
(12) Patent Application Publication
(10) Pub. No.: US 2005/0116388 A1
(43) Pub. Date: Jun. 2, 2005

(54) Method for conditioning polyester and controlling expansion of polyester during thermoforming

(75) Inventor: Donald E. Richeson, North Canton, OH (US)

Correspondence Address: M & G Polymers USA, LLC, 6951 Ridge Road, Sharon Center, OH, 44272-0590, US

(73) Assignee: M&G USA Corporation

(21) Appl. No.: 11/029,764

(22) Filed: Jan. 5, 2005

Related U.S. Application Data
(62) Division of application No. 10/060,157, filed on Jan. 30, 2002.

(51) Int. Cl. B29C 43/02

(52) U.S. Cl. 264/319; 528/480

(57) ABSTRACT

A method for thermoforming a cellular thermoplastic resin comprises exposing a cellular thermoplastic resin to a controlled humidity environment to obtain a conditioned cellular thermoplastic resin, molding the conditioned cellular thermoplastic resin to form a desired shape, and heating the conditioned cellular thermoplastic resin to cause the crystalline content of the thermoplastic resin to be at least about 20-30 percent. A method for conditioning a cellular thermoplastic resin comprises exposing a cellular thermoplastic resin to a controlled humidity environment to obtain a conditioned cellular thermoplastic resin.

### CROSS REFERENCE TO RELATED APPLICATIONS

This application is a divisional of copending U.S. application Ser. No. 10/060,157 filed Jan. 30, 2002. The prior application is hereby incorporated by reference in its entirety.

### BACKGROUND OF THE INVENTION

This invention relates to a process for controlling the expansion of a cellular thermoplastic resin during thermoforming. More particularly, it relates to a method of controlling the expansion of cellular polyester during thermoforming. Specifically, this invention relates to the use of a controlled amount of moisture to control expansion of cellular polyethylene terephthalate during thermoforming.

Thermoplastic containers and trays are commonly used for heat resistant products such as those used for food storage and preparation. These containers may be foamed or non-foamed. They are also used as insulation in other food and industrial applications. Typically, these materials are used with frozen prepared foods which may be heated in conventional or microwave ovens. Such containers may be referred to as dual-ovenable containers. It is desirable for such trays or containers to be able to withstand both freezer temperatures of approximately −30° C. or lower and oven temperatures of about 200° C. or higher without distorting.

Containers which are suitable for such use include polyester containers such as those containing polyethylene terephthalate (PET), polyethylene naphthalate (PEN), polyethylene isophthalate (PEI), poly(butylene terephthalate) (PBT), poly(trimethylene terephthalate) (PTT) or mixtures or copolymers thereof. Polyester polymers may also be modified with other co-monomers incorporating polyethylene (PE), pyromellitic dianhydride (PMDA), neopentyl glycol (NPG), diethylene glycol (DEG), etc. and may also be used in combination with other polymers or modifiers, such as polyolefins, for example.

Articles containing these materials may be formed by thermoforming. Polyester trays and containers for food storage are typically formed by thermoforming because of the relative ease with which thin-walled items can be formed. In the thermoforming process, a preformed sheet of amorphous polyester is heated to a temperature which allows the sheet to be molded into a desired shape. The heated sheet is placed in a mold and forced to conform to the contours of the mold by, for example, application of air pressure, application of a vacuum, plug assist or application of a matching mold. During thermoforming, if a cellular sheet is used the polyester preferably expands by at least about 75 to 100 percent. This expansion, sometimes referred to as post-expansion, provides the article with desired density, impact strength, and insulating properties, for example. Typically, the article is then heat treated while still in the mold to convert the amorphous polyester to a crystalline polyester. Increasing the crystallinity of a polyester resin will increase the rigidity of the polyester, even when subsequently subjected to high temperatures, such as those used in cooking. Therefore, when used for high temperature applications, a polyester will typically be heat treated to at least about 18-40 percent crystallinity, preferably to at least about 20-30 percent crystallinity, and most preferably to at least about 23-26 percent crystallinity.

It has been observed, however, that cellular resins, such as polyethylene terephthalate, for example, will occasionally not exhibit a suitable degree of expansion during thermoforming.

Various methods for heating and post-expanding a foam during thermoforming have been described in the prior art. U.S. Pat. No. 5,482,977 to McConnell et al. describes a post-expansion method which includes immersing the foam in boiling water for two minutes or heating in an air-oven for three minutes. Additionally, U.S. Pat. No. 5,000,991 to Hayashi et al. also describes post-expansion of a polyester resin by heating to 60° C. or higher by contact with heated metal, air, water or steam. When the resin is to be post-expanded by contact with heated water or steam, Hayashi et al. state that it is preferable that the steam or water be introduced into the mold. While control over the expansion ratio of polyester foams has been attempted by varying the composition of the foams, as described by Hayashi et al., for example, it has not been recognized that the expansion ratio of a polyester resin may be adjusted by conditioning the polyester resin by exposing it to controlled enviromnental conditions prior to introduction of the resin into a mold.

### SUMMARY OF INVENTION

It is therefore, an aspect of the present invention to provide a method for conditioning a cellular thermoplastic resin sheet for controlling the expansion ratio of the resin sheet during thermoforming.

It is another aspect of this invention to provide further expansion of an amorphous or only partially crystallized articles which have been further conditioned after initial extrusion.

It is still another aspect of the present invention to provide a method for controlling the expansion ratio of a polyester, as above, that is not dependent on external exposure to steam or heated water.

It is yet another aspect of the present invention to provide a thermoformed container made according to the above method.

At least one or more of the foregoing aspects, together with the advantages thereof over the known art relating to thermoformed containers, which shall become apparent from the specification which follows, are accomplished by the invention as hereinafter described and claimed.

In general, the present invention provides a method for conditioning a cellular thermoplastic resin comprising exposing a cellular thermoplastic resin to a controlled humidity environment to obtain a conditioned cellular thermoplastic resin.

The present invention also includes a method for thermoforming a cellular thermoplastic resin sheet, the method comprising exposing a cellular thermoplastic resin sheet to a controlled humidity environment to obtain a conditioned cellular thermoplastic resin sheet, molding the conditioned cellular thermoplastic resin sheet to form a desired shape, and heating the conditioned cellular thermoplastic resin item to cause the crystalline content of the cellular thermoplastic resin item to be at least about 18-40 percent.

### BRIEF DESCRIPTION OF THE DRAWINGS

FIG. 1 is a graph of moisture content versus final post-expansion thickness of conditioned, thermoformed cellular PET samples;

FIG. 2 is a is a graph of moisture content versus maximum impact load capacity of conditioned, thermoformed cellular PET samples;

FIG. 3 is a is a graph of moisture content versus total impact energy of conditioned, thermoformed cellular PET samples; and

FIG. 4 is a graph of moisture content versus density change of conditioned, thermoformed cellular PET samples.

FIG. 5 is a graph of percent expansion of cellular PET versus water bath temperature according to a method of the prior art.

FIG. 6 is a graph of percent expansion of cellular PET versus water bath temperature according to a method of the prior art.

### PREFERRED EMBODIMENT FOR CARRYING OUT THE INVENTION

As stated above, the present invention provides a method for conditioning a cellular thermoplastic resin sheet comprising exposing a cellular thermoplastic resin to a controlled humidity environment to obtain a conditioned cellular thermoplastic resin. In one embodiment, the cellular thermoplastic resin is a polyester resin. In a more specific embodiment, the cellular thermoplastic resin is selected from the group consisting of polyethylene terephthalate (PET), polyethylene naphthalate (PEN), polyethylene isophthalate (PEI), poly(butylene terephthalate) (PBT), poly(trimethylene terephthalate) (PTT) or mixtures or copolymers thereof.

In general, the method of conditioning includes subjecting a polyester resin or foam sheet to controlled humidity environment for a predetermined period of time or until the moisture content of the polyester foam or resin reaches a predetermined level, such as equilibration. Equilibration is reached when a sample has absorbed about the maximum amount of moisture for a given temperature and relative humidity (RH) and will not absorb significantly more moisture over time. The time required to reach equilibration will depend on a variety of factors such as the moisture level desired, the moisture level prior to the conditioning step, the conditioning temperature, and the RH used. Preferably, the sample is exposed to a controlled humidity environment other than that provided by direct contact with heated water or steam. Since the percent moisture in air varies with temperature, the absolute moisture level is considered in the present invention, rather than various temperature/relative humidity combinations.

A conditioned cellular thermoplastic resin according to the present invention may have any of a variety of moisture levels, but preferably has a moisture level of about 0.44 weight percent water or greater. In another embodiment, a conditioned cellular thermoplastic resin has a moisture level of at least about 0.55 weight percent water. In still another embodiment, a conditioned cellular thermoplastic resin has a moisture level of at least about 0.7 weight percent water.

The present invention also provides a method for thermoforming a cellular thermoplastic resin. According to this method of the present invention, a cellular thermoplastic resin sheet is conditioned, as above, then placed in a mold under conditions which shape the cellular thermoplastic resin sheet, and subsequently heated to cause the cellular thermoplastic resin to have a desired crystalline content.

The present invention also provides a cellular thermoplastic article which has been thermoformed according to the thermoforming method of the present invention. Such articles may be manufactured for use as food containers, especially dual-ovenable food containers.

In order to demonstrate practice of the present invention, cellular polyethylene terephthalate (PET) sheets produced from resin sold under the tradename PETLITE II were exposed to varying environmental conditions and then thermoformed to produce PET trays. All cellular PET sample sheets in this trial were made using an inert gas (nitrogen) to foam the sheets. Samples of PET were conditioned at varying relative humidities (RH) from about 0 percent RH to near 100 percent RH in increments of about 25 percent. The cellular PET sheet samples were all cut from the same roll of sheet stock and randomized prior to the conditioning step to eliminate any cyclic variations in the sheet. Samples were conditioned at go degrees Fahrenheit (32° C.).

Samples 1-4 were subjected to controlled temperatures and relative humidities in an environmental chamber from Envirotonics Company. The highest humidity obtained was 93 percent RH. The sheet samples were conditioned and the moisture periodically tested to determine when moisture equilibrium was reached. Generally, the equilibrium was reached in less than 2 days. The time required to reach equilibration will depend on the size of the sample, the moisture level desired and the moisture level prior to the conditioning step. It is envisioned that the amount of moisture present in a conditioned PET sheet will change with the conditioning temperature, as well as with the RH used.

Samples 5 and 6 were conditioned at 0 percent RH in one of two ways. Sample 5 was conditioned in an oven at 90° F. (32° C.) with DRIERITE (anhydrous calcium sulfate) to collect the moisture. Sample 6 was dried in a vacuum oven for 24 hours at 90° F. (32° C.). The resulting moisture percentage achieved for each sample upon equilibration is summarized in Table I.

TABLE I

| | | Final Moisture |
|---|---|---|
| | Relative Humidity at | Content (weight |
| Sample | 90° F. (32° C.) | percent) |
| 1 | 93% | 0.7 |
| 2 | 75% to 60% | 0.55 |
| 3 | 50% | 0.44 |
| 4 | 25% | 0.34 |
| 5 | 0% | 0.07 |
| 6 | 0% | 0.09 |

The samples were formed on a ZMD vacuum model V223 former using standard conditions for PETLITE II for this thermoformer. These conditions are listed in Table II. Thermoforming temperatures do not get near the melting point for PET and are hot (275-300° F./135-149° C.) for only a few seconds (Table II).

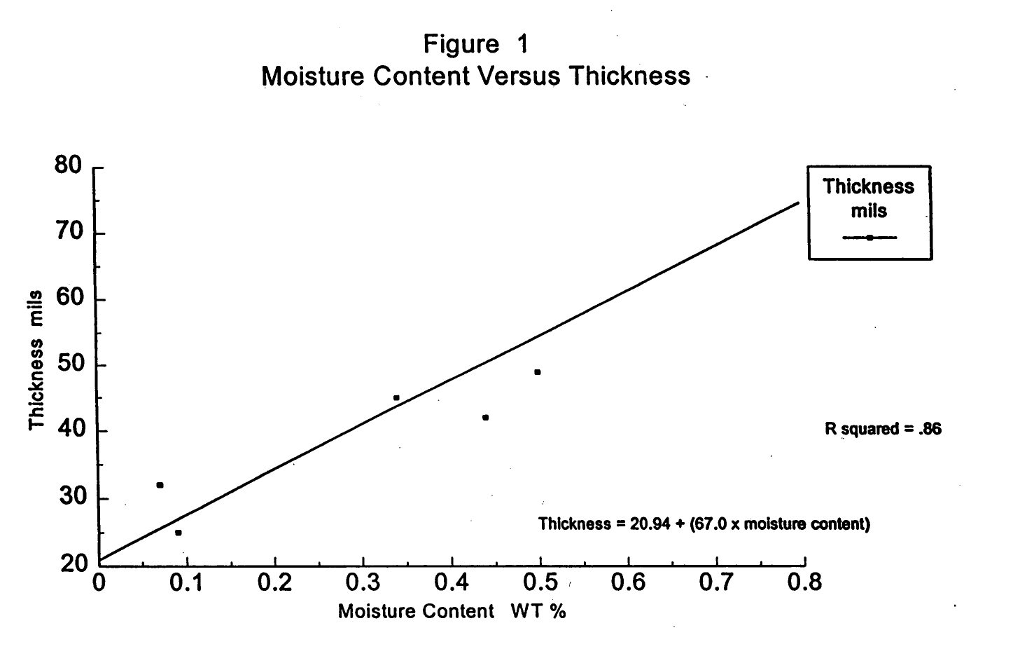

After thermoforming into trays, the samples were tested for impact resistance, percent crystallinity, and density. Testing also included measuring sheet thickness before forming and tray thickness after thermoforming. Moisture determination testing for higher moisture levels (>0.1 weight percent) was performed using a Mitsubishi Moisture Analyzer Model C4-06 and testing for lower moisture levels (<0.1 weight percent) were performed on a Meeco Moisture Analyzer (Model Moisture Master). Impact testing was performed using a Dynatup Model 8250 Impact tester at −20° F. (−29° C.). This test which comprises dropping an instrumented weight onto a clamped sample yields information including the maximum load on the sample before breaking and total energy absorbed by the sample before failure. Results of these tests are shown in Table III and are reprented graphically in FIGS. 1-4.

TABLE II
Processing Conditions For Petlite II Trays
On The ZMD Thermoformer

| Sheet Run # | | L050297-1 |
|---|---|---|
| Mold matched metal | | 5 × 5 × 1 inches @50 mils gap |
| Resin Type | | TTF 2928 |
| Additive | | RDN-1 |
| Sheet Temperature F. | | 260-300 |
| Top oven Heaters % | | 80 |
| Bottom Oven Heaters % | | 80 |
| Oven Temperatures ° F. | BR 1 | 179 |
| | BL2 | 212 |
| | TL₃ | — |
| | TR₄ | 188 |
| Sheet thickness mils | | 26.2 |
| Mold Temperature ° F. | Top | 375 |
| | Bottom | 370 |
| Oven time sec | | 7.0 |
| Mold time sec | Top | 6.0 |
| | Bottom | 7.0 |

| | Bottom | Top |
|---|---|---|
| Platen Delay sec | .008 | .001 |
| Platen Timer sec | 7.0 | 6.0 |
| Bubble Timer | -0- | -0- |
| Main Vac delay sec | .2 | -0- |
| Air eject length sec | .3 | .5 |
| Air eject pause sec | .5 | .2 |
| Number of Ejects | 2 | 2 |
| Vac Bleed delay sec | -0- | -0- |
| Vac Bleed timer sec | -0- | -0- |
| Final eject | -0- | 100 |

TABLE III
Properties of Trays Formed from Conditioned Cellular Petlite II
Original Sheet Thickness = 26.2 mils

| | Final | Percent | Thickness | Max. Load | | Total Energy | | Intrinsic |
|---|---|---|---|---|---|---|---|---|
| No. | Thickness (mils) | Expansion | increase | (lbs) | (kg) | (in-lbs) | (J) | Viscosity |
| 1 | 76 | 190 | 2.90 X | 27 | 12.2 | 4.6 | 0.51 | 0.996 |
| 2 | 49 | 87 | 1.87 X | 26 | 11.8 | 4.2 | 0.47 | 1.002 |
| 3 | 42 | 60 | 1.60 X | 28 | 12.7 | 3.5 | 0.39 | 1.007 |
| 4 | 45 | 72 | 1.72 X | 21 | 9.5 | 2.8 | 0.31 | 0.997 |
| 5 | 32 | 22 | 1.22 X | 23 | 10.4 | 2.5 | 0.28 | 1.012 |
| 6 | 25 | −0.04 | 0.95 X | 14 | 6.4 | 1.5 | 0.16 | 1.013 |

Control sheet Intrinsic Viscosity is 0.961

As shown in Table III and FIG. 1, the thickness of the trays increased as the moisture content of the conditioned cellular PET sheet increased. Samples containing a 0.44 weight percent moisture content displayed an expansion of approximately 60 percent, while samples containing a 0.55 weight percent moisture content displayed an expansion of approximately 87 percent. The later sample also gave good consistency in part thickness. The 0.5 weight percent moisture results from conditioning at 60 percent RH at 90° F. (32° C.). The sample with the highest moisture level (0.7 percent) displayed the greatest expansion. The expansion of the 0.7 weight percent moisture sample to 76 mils is dramatic. The mold was set to be filled at 50 mils but the force of the expansion overcame the ability of the thermoformer to hold the mold shut and the sheet expanded to the recorded 76 mils.

At the extremely low levels of moisture (less than 0.1 weight percent), the lack of full expansion was clear. The samples with 0.07 and 0.09 weight percent moisture were almost the same from a moisture content perspective but the 0.09 weight percent sample was under vacuum for 24 hours prior to forming. It is believed that this form of conditioning left less gas to expand in the sample (with or without moisture) and, therefore, was the thinnest formed sample. As shown in Table III, the effect of vacuum treatment is most noticeable in the impact testing, where Sample 6 had a maximum load capacity of only 14 pounds (6.4 kg) while Sample 5 had a maximum load capacity of 23 pounds (10.4 kg). Other samples had a maximum load capacity between 21 pounds (9.5 kg) and 28 pounds (12.7 kg).

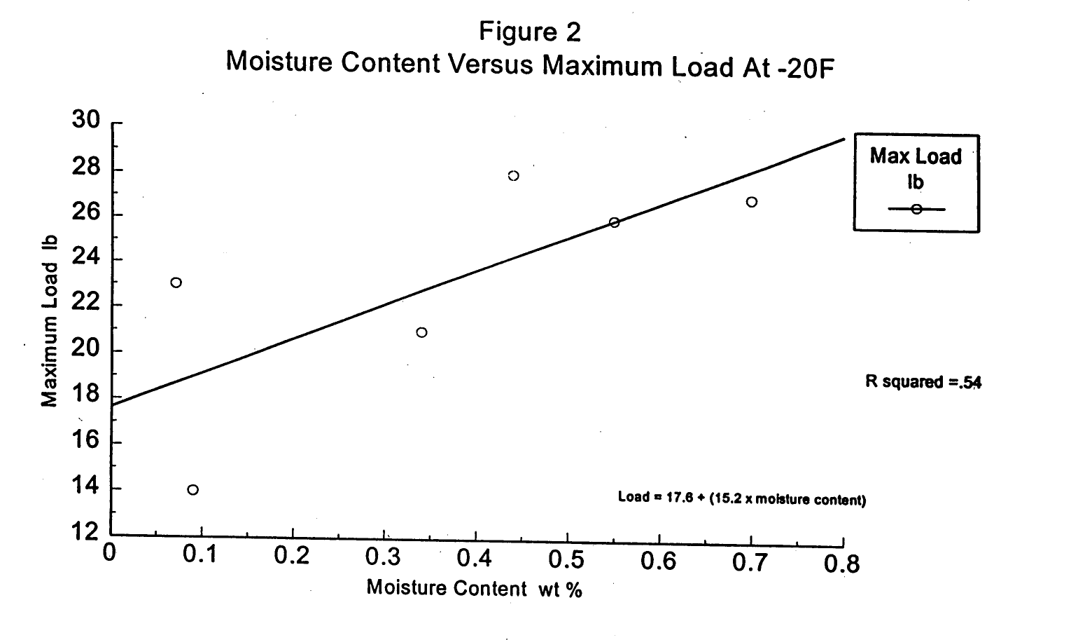

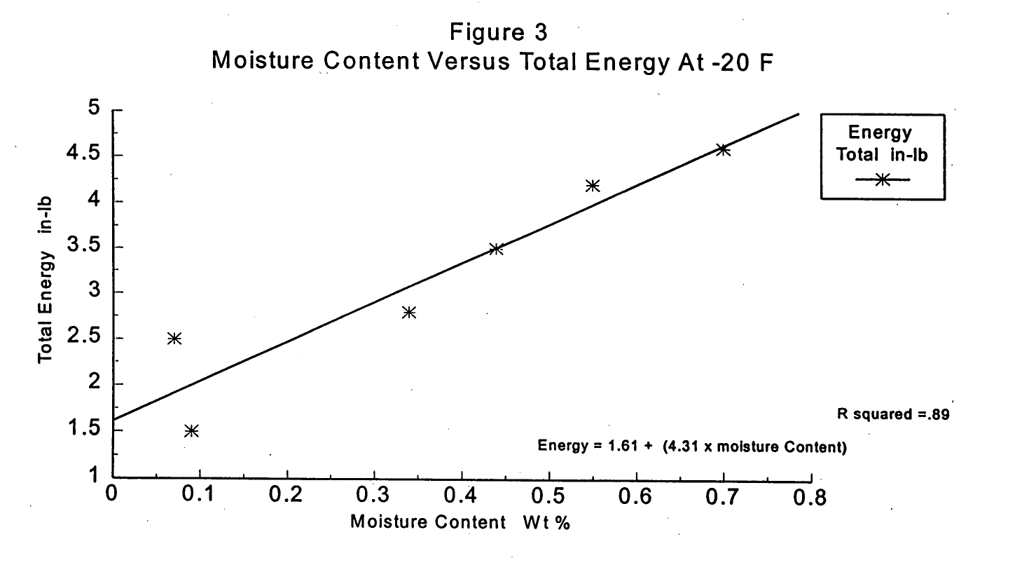

The expansion of the sheet is important since it is normally seen to relate to the impact data of the parts. FIG. 2 shows the curve for the relation of moisture content to maximum load. FIG. 3 and Table III show the total energy for the samples. The linear relationship between the moisture content and the total energy shows good correlation (R²=0.89). The high moisture sample (thickest sample) exhibits the highest total energy of the samples and the energy values decline as the moisture content (and thickness) decline.

Since PET is sensitive to hydrolytic degradation, the samples were also submitted for intrinsic viscosity testing. The intrinsic viscosities of Samples 1-6 are listed in Table III. The moisture content of the PET samples did not negatively affect the intrinsic viscosity of the samples.

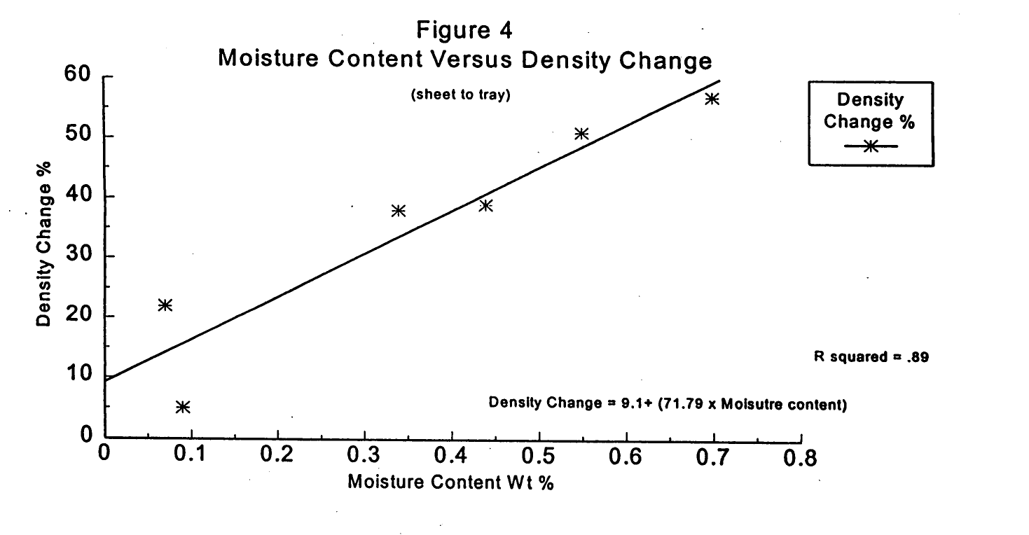

FIG. 4 and Table IV show the relationship between moisture content and density change. A normal density reduction in thermoforming is considered to be between about 30 and about 40 percent. The density changes referred to in FIG. 4 and Table IV refer to the density change going from the sheet to the tray. The values as shown in Table IV show density reductions as great as 57 percent can be obtained during forming. It is believed that the use of matched metal molds may help obtain the maximum expansion. The mold used in these tests was set to give a 50 mil part. It applied a vacuum on both the top and bottom mold halves, both of which were hot to enable fast crystallization of the parts. In some cases, molds using a plug incorporate pressure along with the plug and the thickness is less than desired because the forming pressure mashes the cells.

The samples were also tested for percent crystallinity. As also shown in Table IV, moisture content did not have an observable negative effect on the crystalline content of the samples. All of the data was within the normal range seen for crystallinity. The DSC melting points for the samples were 250° C. with maximum crystallization occurring at 129° C.

TABLE IV
Density And Crystallinity of Trays Formed
from Conditioned Petlite II

| | Moisture | | | Density | | | Crys- |
|---|---|---|---|---|---|---|---|
| | Content | Final Density | | Reduction | Sheet Temp | | tallinity |
| No. | (Wt %) | g/cc | lb/cu ft | (%) | E F | ° C. | percent |
| 1 | 0.70 | 0.174 | 10.8 | 58 | 261 | 127 | 24 |
| 2 | 0.55 | 0.202 | 12.6 | 51 | 276 | 136 | 23 |
| 3 | 0.44 | 0.253 | 15.7 | 39 | 268 | 131 | 24 |
| 4 | 0.34 | 0.254 | 15.8 | 38 | 282 | 139 | 19 |
| 5 | 0.07 | 0.321 | 20.0 | 22 | 289 | 143 | 21 |
| 6 | 0.09 | 0.393 | 24.5 | 5 | 289 | 143 | 20 |

Original Density 0.413 g/cc

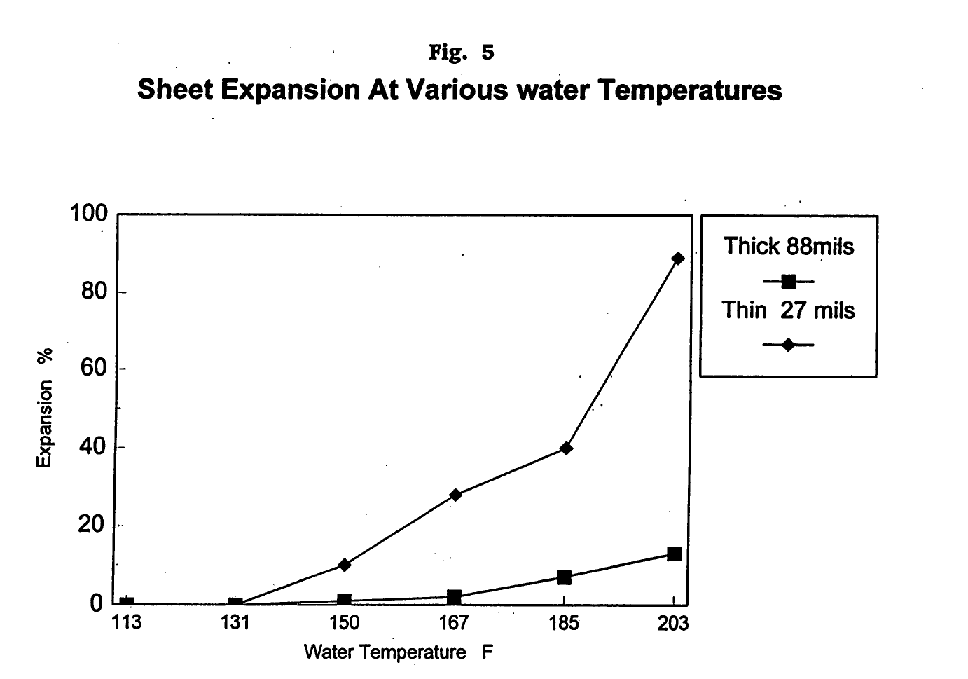

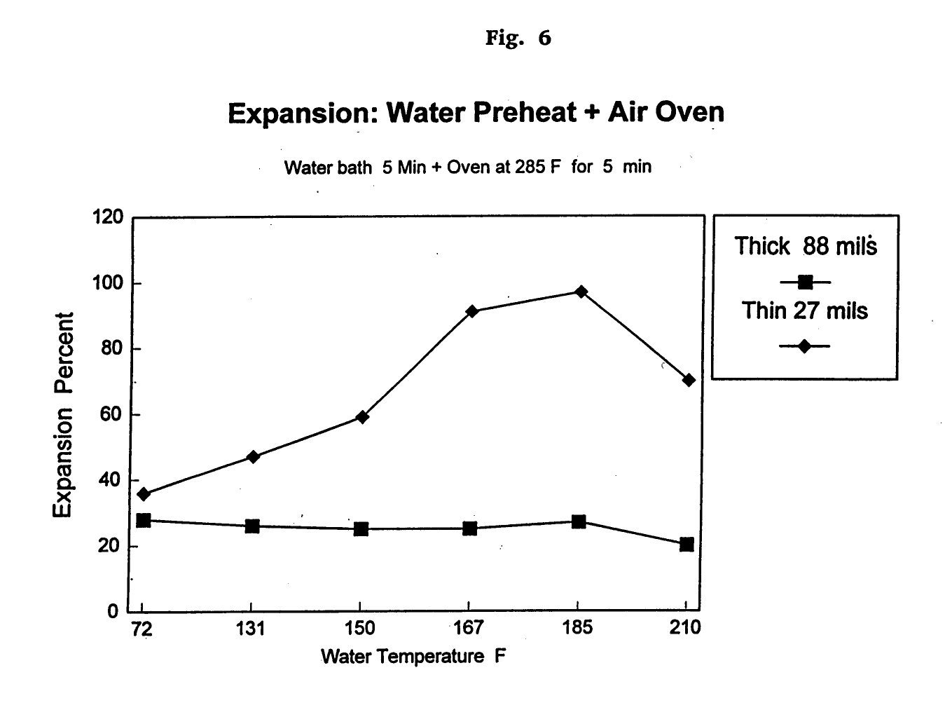

To compare the present invention to prior methods, the expansion of PETLITE II sheets was measured after heating in water and subsequent oven heating as described below. Sheets that were 27 mils thick and 88 mils thick were heated for five minutes in a water bath at temperatures between about 113° F. (45° C.) and about 203° F. (95° C.). The sheets were then heated in an oven at 285° F. (140° C.) for 5 minutes to mimic thermoforming and their thicknesses were measured. The percent expansion was determined for each sample. Results are summarized in FIG. 5, which is a graph of percent expansion versus water bath temperature. A second set of tests were also conducted as described above, except that the temperature of the water bath ranged from about 72° F. (22° C.) to about 210° F. (99° C.). Results of these tests are summarized in FIG. 6. As shown in Table III and FIGS. 5 and 6, the expansion of cellular PET sheets after the conditioning method of the present invention compares favorably to the expansion of PET sheets after immersion in a water bath according to the prior art.

Thus it should be evident that the methods of the present invention are highly effective in providing a method for conditioning a cellular thermoplastic resin for controlling the expansion ratio of the polyester during thermoforming. The invention is particularly suited for polyethylene terephthalate, but is not necessarily limited thereto. The device and method of the present invention can be used separately with other equipment, methods and the like, as well as for the manufacture of other cellular thermoformed resins. It is, therefore, to be understood that any variations evident fall within the scope of the claimed invention and thus, the selection of specific component elements can be determined without departing from the spirit of the invention herein disclosed and described. Thus, the scope of the invention shall include all modifications and variations that may fall within the scope of the attached claims.

1. A method for conditioning a cellular thermoplastic resin comprising exposing a cellular thermoplastic resin to a controlled humidity environment to obtain a conditioned cellular thermoplastic resin.

2. A method for conditioning a cellular thermoplastic resin according to claim 1, wherein the cellular thermoplastic resin is a polyester resin.

3. A method for conditioning a cellular thermoplastic resin according to claim 1, wherein the cellular thermoplastic resin is selected from the group consisting of polyethylene terephthalate, polyethylene naphthalate, polyethylene isophthalate, polybutylene terephthalate, polytrimethylene terephthalate and mixtures and copolymers thereof.

4. A method for conditioning a cellular thermoplastic resin according to claim 1, wherein the step of exposing a cellular thermoplastic resin to a controlled humidity environment comprises exposing the cellular thermoplastic resin to humidity level such that the final moisture level is at least about 0.34 percent by weight.

5. A method for conditioning a cellular thermoplastic resin according to claim 1, wherein the conditioned cellular thermoplastic resin has a moisture level of at least about 0.44 percent by weight.

6. A method for conditioning a cellular thermoplastic resin according to claim 1, wherein the conditioned cellular thermoplastic resin has a moisture level of at least about 0.55 percent by weight.

7. A method for thermoforming a cellular thermoplastic resin, said method comprising:
exposing a cellular thermoplastic resin to a controlled humidity environment to obtain a conditioned cellular thermoplastic resin;
molding said conditioned cellular thermoplastic resin to form a desired shape; and
heating said conditioned cellular thermoplastic resin to cause the crystalline content of the thermoplastic resin to be at least about 20-30 percent.

8. A method for thermoforming a cellular thermoplastic resin according to claim 7, wherein the cellular thermoplastic resin is a polyester resin.

9. A method for thermoforming a cellular thermoplastic resin according to claim 7, wherein the cellular thermoplastic resin is selected from the group consisting of polyethylene terephthalate, polyethylene naphthalate, polyethylene isophthalate, polybutylene terephthalate, polytrimethylene terephthalate and mixtures and copolymers thereof.

10. A method for thermoforming a cellular thermoplastic resin according to claim 7, wherein the step of exposing a cellular thermoplastic resin to a controlled humidity environment comprises exposing the cellular thermoplastic resin to humidity level of at least 25 percent relative humidity at a temperature of at least 32° C.

11. A method for thermoforming a cellular thermoplastic resin according to claim 7, wherein the step of exposing a cellular thermoplastic resin to a controlled humidity environment comprises exposing the cellular thermoplastic resin to humidity level of at least 50 percent relative humidity at a temperature of at least 32° C.

12. A method for thermoforming a cellular thermoplastic resin according to claim 7, wherein the conditioned cellular thermoplastic resin has a moisture level of at least about 0.34 percent by weight.

13. A method for thermoforming a cellular thermoplastic resin according to claim 7, wherein the conditioned cellular thermoplastic resin has a moisture level of at least about 0.44 percent by weight.

14. A method for thermoforming a cellular thermoplastic resin according to claim 7, wherein the conditioned cellular thermoplastic resin has a moisture level of at least about 0.5 percent by weight.

15. A method for thermoforming a cellular thermoplastic resin according to claim 7, wherein the step of heating the cellular thermoplastic resin causes the crystalline content of the cellular thermoplastic resin to reach a predetermined level.

16. A method for thermoforming a cellular thermoplastic resin according to claim 7, wherein the step of heating the cellular thermoplastic resin causes the crystalline content of the cellular thermoplastic resin to be at least about 20 percent.

17-20. (canceled)
